(19) United States
(12) Patent Application Publication
(10) Pub. No.: US 2016/0004443 A1
(43) Pub. Date: Jan. 7, 2016

(54) Overwrite Detection for Control Blocks

(71) Applicant: International Business Machines Corporation, Armonk, NY (US)

(72) Inventor: Darren R. Beard, Hampshire (GB)

(21) Appl. No.: 14/754,962

(22) Filed: Jun. 30, 2015

(30) Foreign Application Priority Data
Jul. 3, 2014 (GB) 1411924.2

(51) Int. Cl. G06F 3/06

(52) U.S. Cl. CPC G06F 3/0604; G06F 3/0659; G06F 3/0673

(57) ABSTRACT

Disclosed is a mechanism for detecting a storage overwrite of a computer program control block, the control block comprising one or more fields. For each field of the one or more fields, the mechanism provides an indication as to whether or not the field is intended to be updated subsequent to initialization of the control block. For each field for which the indication indicates that the field is not intended to be updated subsequent to initialization of the control block, the mechanism checks whether the field has been updated. Response to the checking indicating the field has been updated, the mechanism indicates that a storage overwrite of the computer program control block has occurred.

The present invention relates to overwrite detection for control blocks and more particularly to diagnosing the causes of storage overwrites of control blocks.

A storage overwrite may occur when an application writes to storage which it has not been allocated. The causes of storage overwrites are typically very difficult to diagnose. A common technique for storage overwrite detection is the use of crumple zones which are checked when main storage previously acquired by an application is released. Crumple zones are areas of storage at the start and end of an area of allocated storage, which are each populated with the same known contents when they are allocated. An example of a string which might be used to populate a crumple zone is “C0012345”. The initial character may indicate the user of the storage and/or whether it is 31 bit data or 24 bit data. Later characters may indicate the task number which owns the storage. The string is typically added by a storage manager. When the storage is released, the contents of the crumple zones at the start and end of the area of allocated storage are compared. If either or both of the crumple zones differ from what was originally written, then either or both of the crumple zones have been overwritten. However, this check of crumple zones only detects that a storage overwrite has occurred when the main storage is no longer required and is released. It is not detected when the storage overwrite happens.

Some sort of trap may be used, such as a Serviceability Level Indication Processing (SLIP) trap or the DFHTRAP found in the CICS® Product from IBM® to attempt to obtain diagnostic information at a time closer to when the storage overwrite occurs. A SLIP trap intercepts or traps certain system events, optionally when certain system conditions are present and specifies what actions to take. A SLIP trap used to trap a storage overwrite depends on knowing what address(es) in storage to monitor for storage overwrite. This is often not known for control blocks, which will be at different addresses for different instances of a product initialization. The global trap exit DFHTRAP is an Assembler language program that can be invoked when a CICS trace domain is called to write a trace entry, DPHTRAP is intended to be used by users of the CICS product only under the guidance of service personnel, to make a detailed diagnosis of a problem without having to stop and restart CICS. This has to be provided after there has been a problem. The scenario causing the problem then has to be re-run and the problem reproduced with the DFHTRAP program in place.

United States Patent Application 2009/0282036 A 1 discloses an original dump file being received from a client machine to be forwarded to a dump file recipient. The original dump file is parsed to identify certain content of the original dump file that matches certain data patterns/categories. The original dump file is anonymized by modifying the identified content according to a predetermined algorithm, such that the identified content of the original dump file is no longer exposed, generating an anonymized dump file. Processing logic identifies relevant confidential information patterns/categories in order not to overwrite any technical information required by the third-party. It does not simply overwrite any occurring printable text since this may represent important technical information such as module name or control block identifier (“eye catcher”). The anonymized dump file is then transmitted to the dump file recipient. Technical content and infrastructure of the original dump file is maintained within the anonymized dump file after the anonymization, such that a utility application designed to process the original dump file can still process the anonymized dump file without exposing the identified content of the original dump file to the dump file recipient.

United States Patent Application 2013/0067178 A 1 discloses generating a triage dump of useful memory data from a computer that encounters an error while executing one or more software programs. The computer system may identify data values within the triage dump that are characteristic of personal data. To protect the privacy of the software user the personal data may be poisoned by overwriting the data values with overwrite values. The overwrite values used to poison the data values may be predetermined, based on the data values themselves, or chosen at random. The triage dump may be sent to an external server to associated with the developer of the one or more software programs for analysis. When overwrite values are dynamically selected, the specific overwrite values used may be sent to the server in connection with a triage dump. The overwrite values may be selected to increase the value of the memory dump data in identifying a cause of an error. In some embodiments, the overwrite value may be selected to allow differentiation between memory locations that have been overwritten and memory locations in which information has been retained without being overwritten. In some embodiments, data values characteristic of pointers are retained in the memory dump, without overwrite, and an overwrite value is selected so as to be different than a possible pointer value. As a specific example, an overwrite value may be selected to allow differentiation between locations where the value has been overwritten and locations storing a null pointer.

IP.com Disclosure Number: IPCOM000062069D, “Data Protection Through Detection of Overwritten Control Blocks”, Publication Date: 1 Oct. 1986, discloses that user data may be lost if a system control block, the stored bit map, is overwritten. Improved data protection is achieved by segmenting the stored bit map where each segment contains a prefix, master information bytes, backup information bytes and a suffix, the master and backup bytes provide duplication of the bit map. Tests of prefix and suffix confirm overwrite has not occurred when compare equal results. Tests of master and backup bytes confirm random bits have not occurred when compared equal results. If tests indicate damage to a segment has occurred, this segment is inhibited whilst undamagec segments may be used.

It would be desirable to be able to detect a storage overwrite of a control block when it occurs and without knowing a priori at what address a storage overwrite will occur. It would further be desirable not to require bespoke trap coding or additional runs of the code to recreate problems.

### SUMMARY

In one illustrative embodiment, a method is provided for detecting a storage overwrite of a computer program control block, the control block comprising one or more fields, the method comprises, for each field of the one or more fields, providing an indication as to whether or not the field is intended to be updated subsequent to initialization of the control block. The method further comprising for each field for which the indication indicates that the field is not intended to be updated subsequent to initialization of the control block, checking whether the field has been updated. The method further comprises, responsive to the checking indicating the field has been updated, indicating that a storage overwrite of the computer program control block has occurred.

In another illustrative embodiment, a system is provided for detecting a storage overwrite of a computer program control block, the control block comprising one or more fields. The system comprises a processor and a memory. The memory comprises instructions which, when executed by the processor, cause the processor to provide, for each field of the one or more fields, an indication as to whether or not the field is intended to be updated subsequent to initialization of the control block. The instructions further cause the processor to check, for each field for which the indication indicates that the field is not intended to be updated subsequent to initialization of the control block, whether the field has been updated. The instructions further cause the processor to, responsive to the checking indicating the field has been updated, for indicating that a storage overwrite of the computer program control block has occurred.

In another illustrative embodiment, a computer program product is provided for detecting a storage overwrite of a computer program control block, the control block comprising one or more fields. The computer program product comprises a computer readable storage medium having computer readable program code embodied therewith, the computer readable program code adapted to perform the method described above when the program is run on a computer.

### BRIEF DESCRIPTION OF THE SEVERAL VIEWS OF THE DRAWINGS

Illustrative embodiments of the present invention will now be described in more detail, by way of example only, with reference to the accompanying drawings, in which:

FIG. 1 shows a block diagram of a prior art area of storage having crumple zones;

FIG. 2 shows a prior art control block;

FIG. 3 shows an embodiment of a control block of the illustrative embodiment;

FIG. 4 shows a flow chart of the operation of a first illustrative embodiment;

FIG. 5 shows a flow chart of the operation of a second illustrative embodiment; and

FIG. 6 shows a block diagram of an architecture within which the illustrative embodiments may be implemented.

### DETAILED DESCRIPTION

FIG. 1 shows a block diagram of a prior art area of allocated storage 100 having crumple zones 102, 108. Prior art crumple zones 102, 108 are areas of storage at the start 102 and end 108 of an area of allocated storage 100, which are each populated with the same known contents, such as string, when they are allocated. An example of a string which might be used to populate a crumple zone 102, 108 is “C0012345”. The initial character may indicate the user of the allocated storage 100 and/or whether it is 31 bit data or 24 bit data. Later characters may indicate the task number which owns the allocated storage 100. The string is typically added by a storage manager and may be any number of bytes long, but is typically eight bytes long. When the allocated storage 100 is released, the contents of the crumple zones 102, 108 at the start 102 and end 108 of the area of allocated storage 100 are compared. If either or both of the crumple zones 102, 108 differ from what was originally written, then either or both of the crumple zones 102, 108 have been overwritten. However, this check of crumple zones 102, 108 only detects that a storage overwrite has occurred when the allocated storage 100 is no longer required and is released. It is not detected when the storage overwrite happens.

FIG. 1 also shows prior art eyecatcher 104. Eyecatchers 104 are usually text, typically located in the first 16 bytes, or characters, of the control block. The eyecatcher 104 identifies the control block. In the example of FIG. 1, the eyecatcher 104 is the text string “>DFHTSANCHOR”. The text string may be padded out to make it 16 bytes long or it may be any other number of bytes long. In the example of FIG. 1, the “>DFH” portion indicates the owner of the control block and the “TSANCHOR” indicates the function of the control block, in this case a temporary storage anchor block. The eyecatcher 104 text string is added when the control block is initialized. The contents of the control block are shown at 106 in FIG. 1. Contents of an exemplary control block may be any number of fields of any type such as characters (char), binary values (bin) or pointers (ptr).

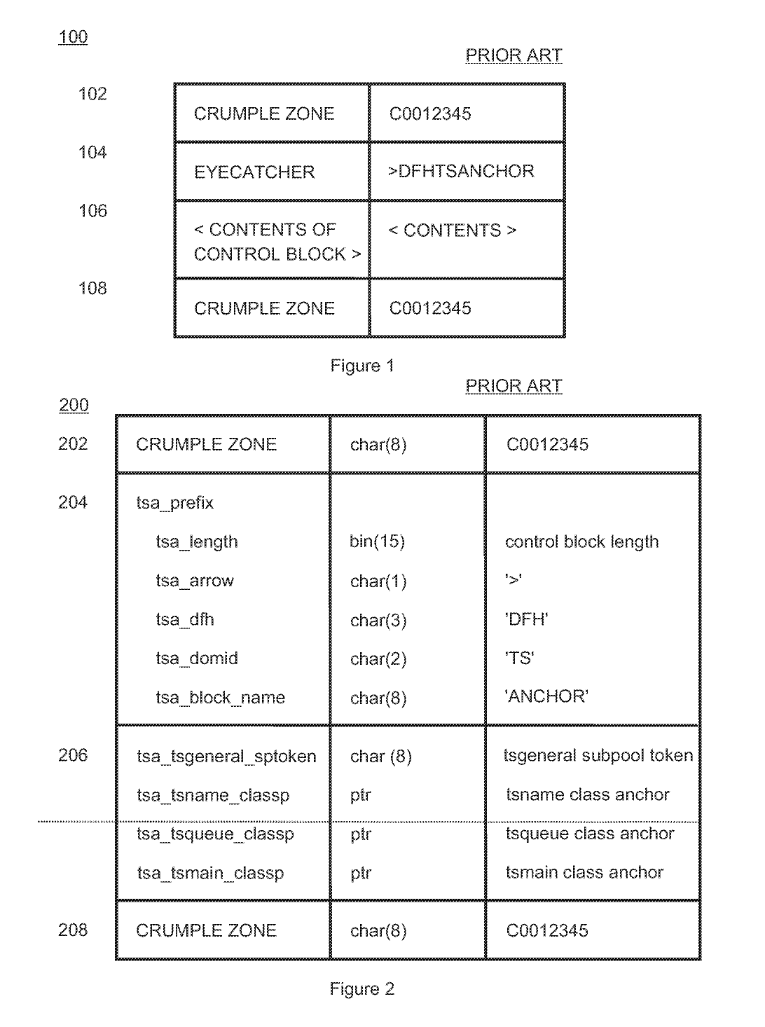

FIG. 2 shows a prior art control block 200. Crumple zones 202, 208 at the start 202 and end 208 of the control block 200 correspond with the prior art crumple zones 102, 108 of FIG. 1. tsa_prefix is a prior art eyecatcher 204 comprising a binary value tsa_length indicating the control block length and character fields for tsa_arrow, tsa_dfh, tsa_domid and tsa_blockname for the elements of the eyecatcher text string “>DFFITSANCHOR” indicating the owner of the control block 200 and the function of the control block 200. The contents 206 of the control block 200 comprise the character field tsa_tsgeneral_sptoken which is the tsgeneral subpool token followed by three pointers, tsa_tsname_classp to the tsname class anchor, tsa_tsqueue_classp to the tsqueue class anchor and tsa_tsmain_classp to the tsmain class anchor. As in the prior art example of FIG. 1, the crumple zones 202, 208 and eyecatcher 204 are not restricted to the lengths shown in the example, nor are they restricted as to the specific content.

The control block of FIG. 2 is conventionally defined using statements such as:

| dcl tsa bdy(dword) based, | | |
|---|---|---|
| tsa_prefix, | | |
| tsa_length | bin(15), | ! control block length |
| tsa_arrow | char(1), | ! ‘>’ |
| tsa_dfh | char(3), | ! ‘DFH’ |
| tsa_domid c | har(2), | ! ‘TS' |
| tsa_block_name | char(8), | ! ‘ANCHOR’ |
| tsa_tsgenral_sptoken | char(8), | ! tsgenral subpool token |
| tsa_tsname_classp | ptr, | ! -> tsname class anchor |
| tsa_tsqueue_classp | ptr, | ! -> tsqueue class anchor |
| tsa_tsmain_classp | ptr, | ! -> tsmain class anchor |

to define the DFHTSANCHOR control block eyecatcher 204 and contents 206. Crumple zones 202, 208 are added by a storage manager.

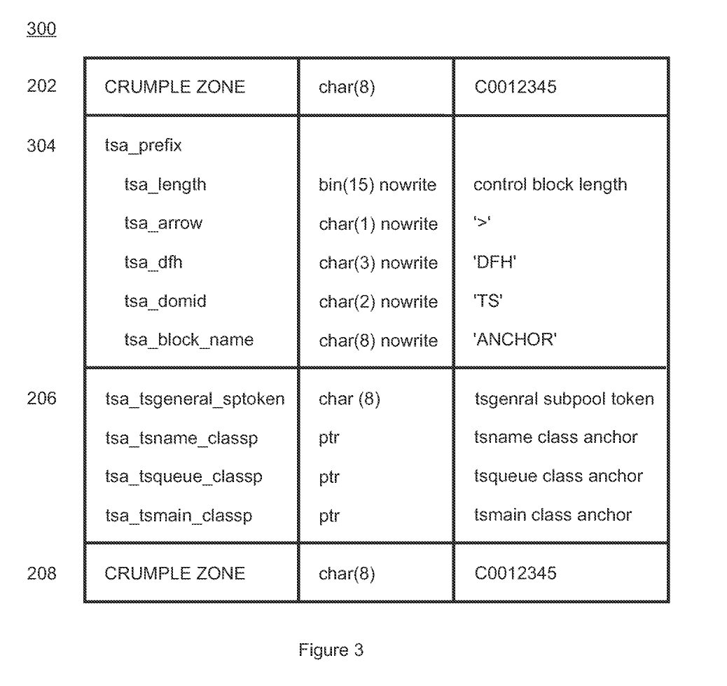

FIG. 3 shows a control block 300 according to an illustrative embodiment. Crumple zones 202 and 208, added by the storage manager, correspond with those of FIG. 2. Contents 206 of the control block 300 correspond with that of FIG. 2 and represent areas of the control block 300 which need to change, such as pointers, addresses and flags.

The embodiment of the control block 300 of FIG. 3 includes the capability of detecting overwrites of specific parts of the control block 300. Most conventional control blocks 300 will contain items which need to change, such as addresses and flags, but also items which must not change, such as eyecatchers 304 or crumple zones 202, 208. Because control blocks 300 contain fields which need to change, control blocks 300 cannot reside in write protected storage. Because the control blocks are typically relocatable, hard-coded memory overwrite checking is typically not possible. Rewritable fields mean that the control blocks cannot be permanently in write-protected memory. Trap code, such as a SLIP trap or DFHTRAP described above permanently running for all locations is infeasible. There is usually a need for special case code to order to recreate and trap overwrites.

When a control block 300 of the present invention is implemented in a computer system, the computer system can be configured to have sufficient knowledge of the control block 300 structures that it recognizes when a field which should not change is being overwritten and generates diagnostic material such as a system dump at that time. This means that the prior art First Failure Data Capture (FFDC) is captured close to the time of the storage overwrite without the intervention of service personnel.

When a control block 300 is defined, in addition to defining the structure of the control block 300, the definition includes information specifying whether or not the field is expected to change subsequent to initial setup of the control block 300. The eyecatcher 304 in the control block may be defined as not to accept overwrite. An address, such as the pointers in the example of FIG. 3, may be defined as being capable of overwrite. The whole control block 300 is not write protected, as it cannot be in order to perform its function as a control block 300. Only the unchangeable fields (bytes or bits) are effectively write protected after being initialized.

In a running system, should an overwrite occur, there is be a high probability of one of the protected areas 304 of a control block 300 being overwritten. This may trigger the system to take a system dump.

The control block of FIG. 3 according to an embodiment of the present invention is defined using statements such as:

| | | |
|---|---|---|
| dcl tsa bdy(dword) based, | | |
| tsa_prefix, | | |
| tsa_length | bin(15) nowrite, | ! control block length |
| tsa_arrow | char(1) nowrite, | ! ‘>’ |
| tsa_dfh | char(3) nowrite, | ! ‘DFH’ |
| tsa_domid | char(2) nowrite, | ! ‘TS’ |
| tsa_block_name | char(8) nowrite, | ! ‘ANCHOR’ |
| tsa_tsgenral_sptoken | char(8), | ! tsgenral subpool token |
| tsa_tsname_classp | ptr, | ! -> tsname class anchor |
| tsa_tsqueue_classp | ptr, | ! -> tsquene class anchor |
| tsa_tsmain_classp | ptr, | ! -> tsmain class anchor |

to define the DFHTSANCHOR control block eyecatcher 304 and contents 206. Crumple zones 202, 208 are added by a storage manager.

The statements above differ from those described earlier and used to define the control block 200 of FIG. 2. In the statements used to define the control block 300 of FIG. 3, the fields of the eyecatcher are defined with a “nowrite” attribute to the field type, that is bin(15) nowrite or char(n) nowrite, where (n) in the example of FIG. 3 is 1, 3, 2 or 8.

Although in the exemplary embodiment of FIG. 3 the definition of the fields of the eyecatcher 304 have been defined as being expected not to change subsequent to the initial setup of the control block using an attribute of “nowrite”, other embodiments may use a different attribute such as “writedisabled” or any other attribute which indicates that those fields of the control block are expected not to change subsequent to the initial setup of the control block. Further embodiments may use means other than an attribute of defining the control block as not to change subsequent to the initial setup of the control block.

Other fields such as tsa_tsname_classp, tsa_tsqueue_classp and tsa_tsmain_classp are pointers to other control blocks. These are typically initialized to zero, but are expected to be set to point to these other control blocks when the other control blocks are set up. These other fields are not defined with the “nowrite” attribute.

Embodiments of the present invention have the advantages that there is no need for bespoke trap coding or runs of the code to recreate problems. There is further no need to run the code with conventional trapping permanently on. There is a low data overhead, as only some fields need identifying as being expected not to change subsequent to initial setup of the control block 300. Yet further, embodiments of the present invention can be implemented at any level in the machine-to-application-layer stack.

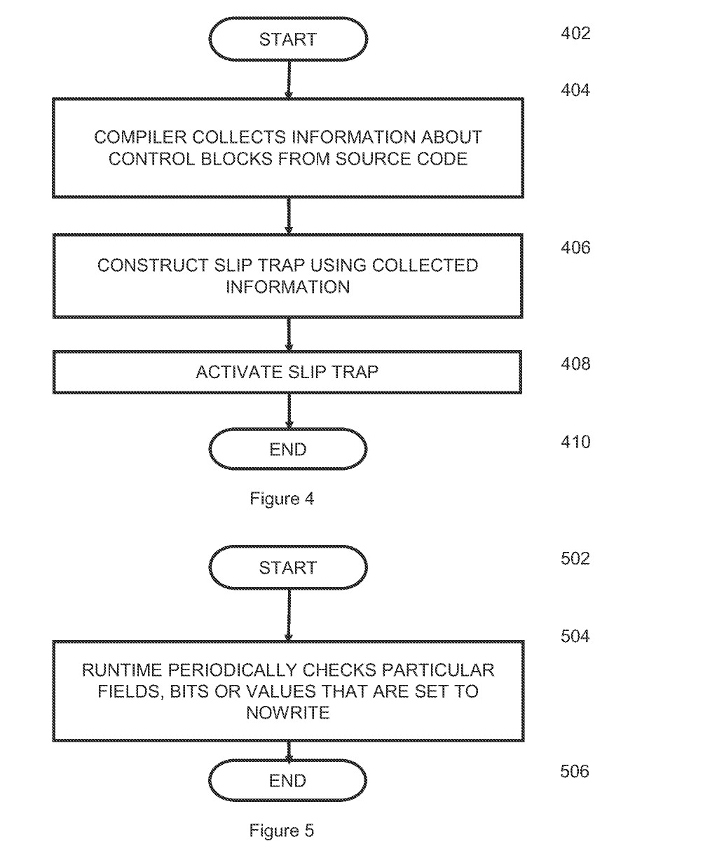

FIG. 4 shows a flow chart of a method of detecting of storage overwrite according to a first illustrative embodiment. The method starts at step 402. At step 404, the compiler collects information about control blocks from the source code. In the example of FIG. 3, the relevant information is which fields have the “nowrite” attribute. At step 406, SLIP traps are constructed for the control blocks 300 using the collected information. Normal SLIP traps are not useful for the detection of storage overwrite in relocatable control blocks 300 because the address in storage of the control blocks 300 is not known in advance. The constructed SLIP trap can detect storage overwrite errors immediately and assist with problem determination and resolution. At step 408, the SUP trap can be activated. Optionally, step 408 of activating the SLIP trap may be executed only when required (in much the same way as slip traps are already used). Activating the SLIP trap only when required minimizes the performance overhead of the SLIP trap. Operation ends in step 410.

FIG. 5 shows a flow chart of a method of detecting storage overwrite according to a second illustrative embodiment. The method starts at step 502. At step 504, a checking facility within the runtime (for example, CICS) periodically checks particular fields, bits or values that must not change and are defined as such, for example, by using the “nowrite” attribute described above. This second embodiment has the disadvantage that it does not detect storage overwrite errors immediately but it is much cheaper in performance terms to implement. Performance impact may be controlled in a flexible way by controlling if and when the runtime does the checks of the particular fields. Operation ends in step 506.

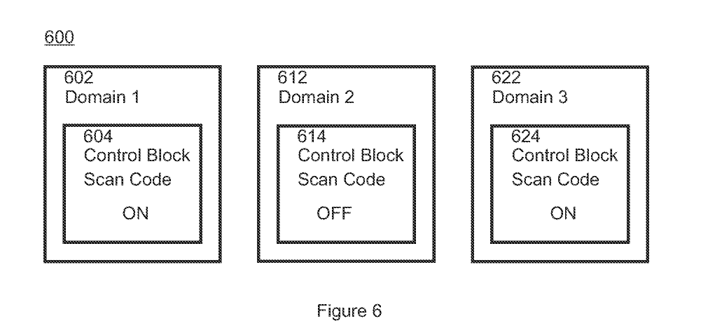

FIG. 6 shows a block diagram of an architecture within which the illustrative embodiments may he implemented. Embodiments of the invention may he implemented at a hardware level with suitable machine architecture or at a software level. FIG. 6 shows an implementation in a software product such as the CICS product from IBM. If the software product has a well structured domain architecture (such as the CICS product has) the implementation may be at the domain level. FIG. 6 shows three domains 602, 612, 622. Each of the domains has control block scan code 604, 614, 624 that scans the control blocks 300 using one of the embodiments of FIG. 4 or FIG. 5 or another embodiment.

If the system 600 containing the software product is experiencing an overwrite of control block 300 eyecatchers 304 in domain 3 622, control block scan code 624 may be added into domain 3 622 such that when the control block scan code 624 is called, the control block scan code 624 scans control blocks 300 located within domain 3 622 and takes appropriate FFDC actions when a storage overwrite of the control blocks 300 is detected.

In the system 600, it may, however, be code in domain 1 602 which is incorrectly addressing something in domain 3 622 and causing the storage overwrite. If this is the case, then domain 3 622 needs to check the control blocks 300 within domain 622 more frequently. This may be implemented in a similar manner to trace in the CICS product, which is controlled at the domain 602, 612, 622 level. Control block 300 checking can be turned on or off at the domain 602, 612, 622 level. If a storage overwrite is induced by a particular test case or transaction only the domains 602, 612, 622 which the particular test case or transaction uses need to perform control block 300 checking. Code may be added to every domain 602, 612, 622 to enable the control block 300 checks to occur and this can be dynamically turned on or off as required. In the example of FIG. 6, the control block scan code 604 in domain 1 602 is turned on as is the control block scan code 624 in domain 3 622. The control block scan code 614 in domain 2 612 is turned off.

Embodiments of the method of detecting storage overwrites are very different from merely using SLIP traps or DFHTRAP style code. The embodiments do not depend on knowing a priori at what address a storage overwrite will occur. The embodiments enable checking of all items in multiple control blocks 300 which should never be changed after initialization.

From a service point of view, the embodiments virtually remove the need ever to write DFHTRAP code for internal overwrite problems in software products, such as, for example, the CICS product from IBM. From a customer point of view, the embodiments enable collection of good quality diagnostic material easily without the need to raise a Problem Management Record (PMR), ask the service portion of the supplier of the software product for a trap and then attempt to reproduce the problem. The illustrative embodiments allow more rapid diagnosis of problems with lower service cost and overhead with concomitant increase in customer satisfaction.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable progammable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the users computer, partly on the users computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for detecting a storage overwrite of a computer program control block, the control block comprising one or more fields, the method comprising:
for each field of said one or more fields, providing an indication as to whether or not said field is intended to be updated subsequent to initialization of said control block;
for each field for which said indication indicates that said field is not intended to be updated subsequent to initialization of said control block, checking whether said field has been updated; and
responsive to said checking indicating said field has been updated, indicating that a storage overwrite of said computer program control block has occurred.

2. A method as claimed in claim 1, wherein:
providing an indication as to whether or not said field is intended to be updated subsequent to initialization of said control block is completed at compile time, said indication comprising address information of each of said one or more fields of said control block that are not intended to be updated subsequent to initialization of said control block; and
checking whether said field has been updated comprises constructing a slip trap using said address information to trap updates to the addresses of said one or more fields of said control block that are not intended to be updated subsequent to initialization of said control block.

3. A method as claimed in claim 1, wherein said constructed slip trap is activated only when required.

4. A method as claimed in claim 1, wherein checking whether said field has been updated comprises periodic checks by said computer program owning said control blocks using said indication as to whether or not said field is intended to be updated subsequent to initialization of said control block to trap updates to the addresses of said one or more fields of said control block that are not intended to be updated subsequent to initialization of said control block.

5. A method as claimed in claim 1, wherein said indication as to whether or not said field is intended to be updated subsequent to initialization of said control block comprises an attribute associated with the type definition.

6. A method as claimed in claim 1, wherein said field that is not intended to be updated subsequent to initialization of said control block comprises an eyecatcher.

7. A method as claimed in claim 1, wherein:
said computer program executes in a plurality of domains; and
said checking is enabled or disabled individually for each of the plurality of domains.

8. A system for detecting a storage overwrite of a computer program control block, the control block comprising one or more fields, the system comprising:
a processor; and
a memory coupled to the processor, wherein the memory comprises instructions which, when executed by the processor, cause the processor to:
provide, for each field of said one or more fields, an indication as to whether or not said field is intended to be updated subsequent to initialization of said control block;
check, for each field for which said indication indicates that said field is not intended to be updated subsequent to initialization of said control block, whether said field has been updated; and
responsive to said checking indicating said field has been updated, indicate that a storage overwrite of said computer program control block has occurred.

9. A system as claimed in claim 8, wherein:
providing an indication as to whether or not said field is intended. to be updated subsequent to initialization of said control block operates at compile time, said indication comprises address information of each of said fields of said control block which are not intended to be updated subsequent to initialization of said control block;
checking whether said field has been updated comprises constructing a slip trap using said address information to trap updates to the addresses of said one or more fields of said control block which are not intended to be updated subsequent to initialization of said control block.

10. A system as claimed in claim 9, wherein said constructed slip trap is activated only when required.

11. A system as claimed in claim 8, wherein checking whether said field has been updated comprises causing said computer program owning said control block to complete periodic checks using said indication as to whether or not said field is intended to be updated subsequent to initialization of said control block to trap updates to the addresses of said one or more fields of said control block that are not intended to be updated subsequent to initialization of said control block.

12. A system as claimed in claim 8, wherein said indication as to whether or not said field is intended to be updated subsequent to initialization of said control block comprises an attribute associated with the type definition.

13. A system as claimed in claim 8, wherein said field that is not intended to be updated subsequent to initialization of said control block comprises an eyecatcher.

14. A system as claimed in claim 8, wherein:
said computer program executes in a plurality of domains; and
said checking is enabled or disabled individually for each plurality of domains.

15. A computer program product for detecting a storage overwrite of a computer program control block, the control block comprising one or more fields, the computer program product comprising:
a computer readable storage medium having computer readable program code embodied therewith, the computer readable program code adapted to perform;
providing, for each field of said one or more fields, an indication as to whether or not said field is intended to be updated subsequent to initialization of said control block;
checking, for each field for which said indication indicates that said field is not intended to be updated subsequent to initialization of said control block, whether said field has been updated; and
responsive to said checking indicating said field has been updated, indicating that a storage overwrite of said computer program control block has occurred.

16. A computer program product as claimed in claim 15, wherein:
providing an indication as to whether or not said field is intended to be updated subsequent to initialization of said control block is completed at compile time, said indication comprising address information of each of said one or more fields of said control block that are not intended to be updated subsequent to initialization of said control block; and
checking whether said field has been updated comprises constructing a slip trap using said address information to trap updates to the addresses of said one or more fields of said control block that are not intended to be updated subsequent to initialization of said control block.

17. The computer program product of claim 15, wherein checking whether said field has been updated comprises periodic checks by said computer program owning said control blocks using said indication as to whether or not said field is intended to be updated subsequent to initialization of said control block to trap updates to the addresses of said fields of said one or more control block that are not intended to be updated subsequent to initialization of said control block.

18. The computer program product of claim 15, wherein said indication as to whether or not said field is intended to be updated subsequent to initialization of said control block comprises an attribute associated with the type definition.

19. The computer program product of claim 15, wherein said field that is not intended to be updated subsequent to initialization of said control block comprises an eyecatcher.

20. The computer program product of claim 15, wherein:
said computer program executes in a plurality of domains; and
said checking is enabled or disabled individually for each of the plurality of domains.
